(19) United States
(12) Patent Application Publication
(10) Pub. No.: US 2018/0265164 A1
(43) Pub. Date: Sep. 20, 2018

(54) BOTTOM BRACKET DEVICE AND A BICYCLE FRAME WITH THE SAME

(71) Applicant: A-PRO TECH CO., LTD., Taichung City (TW)

(72) Inventors: Seng-Chyi LI, Miaoli City (TW); Shun-Min HSU, Guosing Township (TW)

(73) Assignee: A-PRO TECH CO., LTD., Taichung City (TW)

(21) Appl. No.: 15/711,570

(22) Filed: Sep. 21, 2017

(30) Foreign Application Priority Data
Mar. 20, 2017 (TW) 106203875

(51) Int. Cl. B62K 25/28; B62K 3/04

(52) U.S. Cl. CPC B62K 25/286; B62K 3/04

(57) ABSTRACT

A bottom bracket device includes a bottom bracket shell, and a first down tube and a first seat tube both connected to and extending from the bottom bracket shell. The first seat tube defines therein a receiving space with a rear access opening. A rear fork assembly has a front end portion inserted from the opening to be concealed in the space and pivotably connected to the first seat tube. A bicycle frame includes the above-mentioned bottom bracket device, a front frame body, a rear frame body and a shock absorber.

### CROSS-REFERENCE TO RELATED APPLICATION

This application claims priority of Taiwanese Patent Application No. 106203875, filed on Mar. 20, 2017.

### FIELD

The disclosure relates to a bicycle frame, and more particularly to a bicycle frame having a bottom bracket device in which a pivot space is defined for accommodating a front pivot end portion of a rear fork assembly.

### BACKGROUND

Referring to FIG. 1, a conventional cross-country bicycle frame 1 includes a front frame body 2, a rear frame body 3 and a suspension 4 disposed between the front and rear frame bodies 2, 3. The rear frame body 3 includes a lower seat tube 301, a chain stay 302 connected with the lower seat tube 301, and a rear stay 303 connected with both the lower seat tube 301 and the chain stay 302. The chain stay 302 has two forks 304 pivotably connected to two opposite sides of the lower seat tube 301, respectively. The suspension 4 is disposed to control the amount of movement between the rear frame body 3 and the front frame body 2.

Since the front ends of the forks 304 are disposed to project laterally and outwardly of the opposite sides of the lower seat tube 301, an undesired wind resistance is produced and adversely affect movement of the bicycle frame 1. Moreover, the projecting forks 304 negatively affect the outer appearance of the bicycle frame 1.

### SUMMARY

Therefore, an object of the disclosure is to provide a bottom bracket device and a bicycle frame with the same that can alleviate at least one of the drawbacks of the prior art.

According to the disclosure, a bottom bracket device includes a bottom bracket shell, a first down tube, a first seat tube and a rear fork assembly. The bottom bracket shell surrounds a spindle axis in a left-and-right direction to have left and right opened ends. The first down tube is connected to and extends forwardly from the bottom bracket shell. The first seat tube is connected to and extends upwardly from the bottom bracket shell, and has two side walls which are disposed between the left and right opened ends in the left-and-right direction. The side walls define therebetween a receiving space which has a rear access opening that is opposite to the first down tube in a front-and-rear direction. The rear fork assembly has at least one front end portion which is inserted into the receiving space from the rear access opening and which is pivotably connected to the side walls of the first seat tube about a pivot axis in the left-and-right direction.

According to the disclosure, a bicycle frame includes a bottom bracket device as mentioned above, a front frame body, a rear frame body and a shock absorber. The front frame body includes a second down tube which is connected to and extends forwardly and upwardly from the first down tube, and a second seat tube which is connected to and extends upwardly from the first seat tube. The rear frame body includes two chain stay forks each of which is connected to and extends rearwardly from the rear fork assembly, and a rear stay which is connected to and extends forwardly and upwardly from the chain stay forks. The shock absorber is disposed between the front frame body and the rear stay.

### BRIEF DESCRIPTION OF THE DRAWINGS

Other features and advantages of the disclosure will become apparent in the following detailed description of the embodiment with reference to the accompanying drawings, of which:

FIG. 1 is a schematic side view of a conventional cross-country bicycle frame;

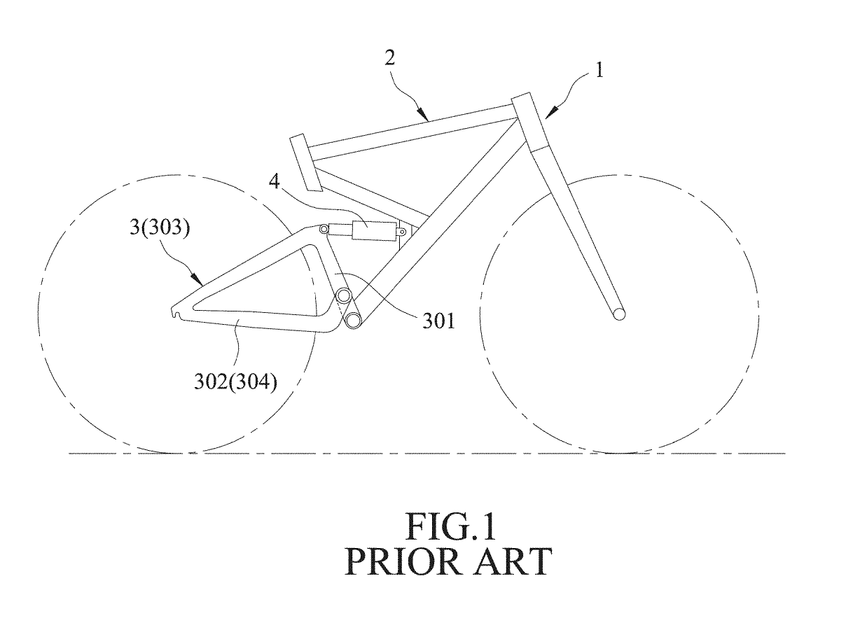

FIG. 2 is a perspective view illustrating an embodiment of a bicycle frame according to the disclosure;

FIG. 3 is a partly exploded perspective view of the embodiment;

FIG. 4 is a sectional view taken along line IV-IV of FIG. 2; and

FIG. 5 is a sectional view taken along line V-V of FIG. 4.

### DETAILED DESCRIPTION

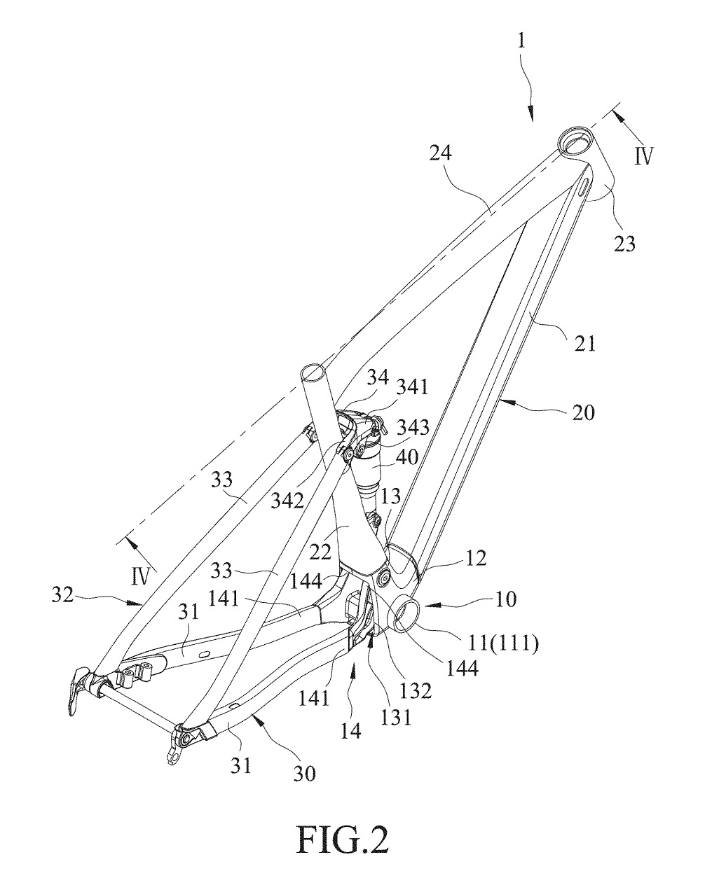

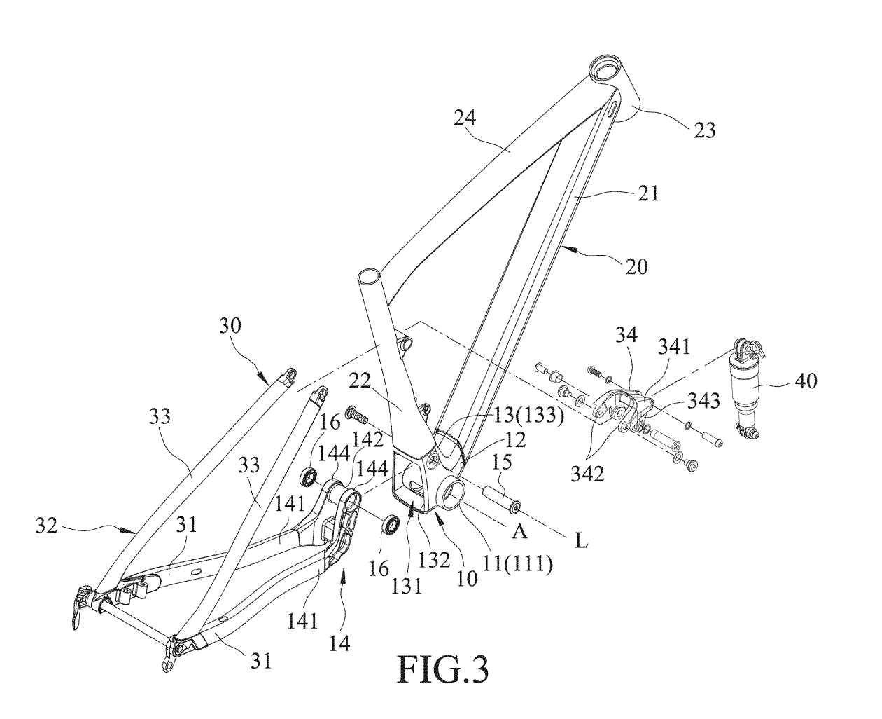

Referring to FIGS. 2 to 4, an embodiment of a bicycle frame 1 according to the disclosure includes a bottom bracket device 10, a front frame body 20, a rear frame body 30 and a shock absorber 40.

The bottom bracket device 10 includes a bottom bracket shell 11, a first down tube 12, a first seat tube 13, a rear fork assembly 14, a pivot shaft 15 and two anti-friction bearings 16.

The bottom bracket shell 11 surrounds a spindle axis (A) in a left-and-right direction to have left and right opened ends 111. The first down tube 12 is connected to and extends forwardly from the bottom bracket shell 11. The first seat tube 13 is connected to and extends upwardly from the bottom bracket shell 11, and has two side walls 133 which are disposed between the left and right opened ends 111 of the bottom bracket shell 11 in the left-and-right direction. The side walls 133 define therebetween a receiving space 131 which has a rear access opening 132 that is opposite to the first down tube 12 in a front-and-rear direction. In this embodiment, a lower end of the first seat tube 13 is connected to a lower end of the first down tube 12 at the bottom bracket shell 11.

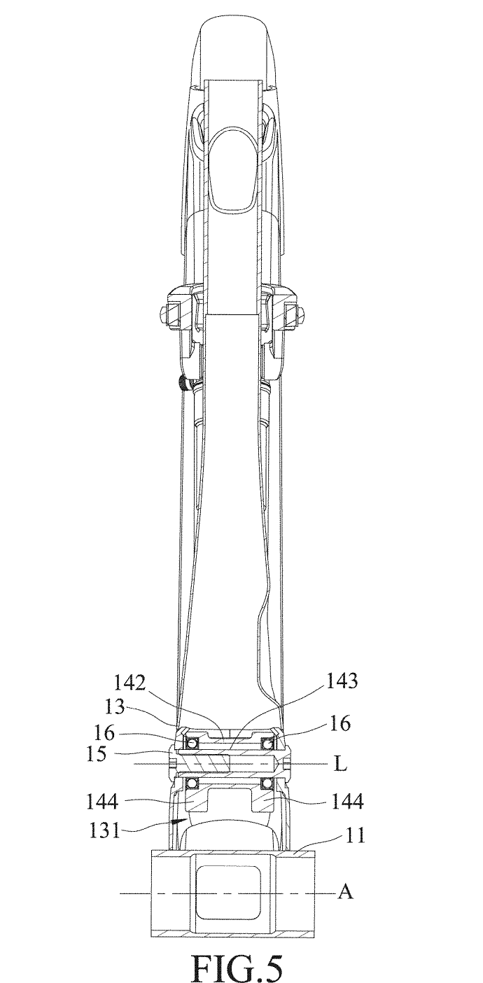

The rear fork assembly 14 includes two rear fork rods 141, a tubular crosspiece 142 and an axial hole 143 (see FIG. 5). Each of the rear fork rods 141 has, at a front end thereof, a front end portion 144 which is inserted into the receiving space 131 from the rear access opening 132 and which is pivotably connected to a respective one of the side walls 133 of the first seat tube 13 about a pivot axis (L) in the left-and-right direction. The front end portions 144 of the rear fork rods 141 are spaced apart from each other in the left-and-right direction. Specifically, the front end portion 144 of each rear fork rod 141 is disposed upwardly of the bottom bracket shell 11.

The tubular crosspiece 142 extends in the left-and-right direction to interconnect the front end portions 144. In this embodiment, the tubular crosspiece 142 is integrally connected with the front end portions 144 of the rear fork rods 141.

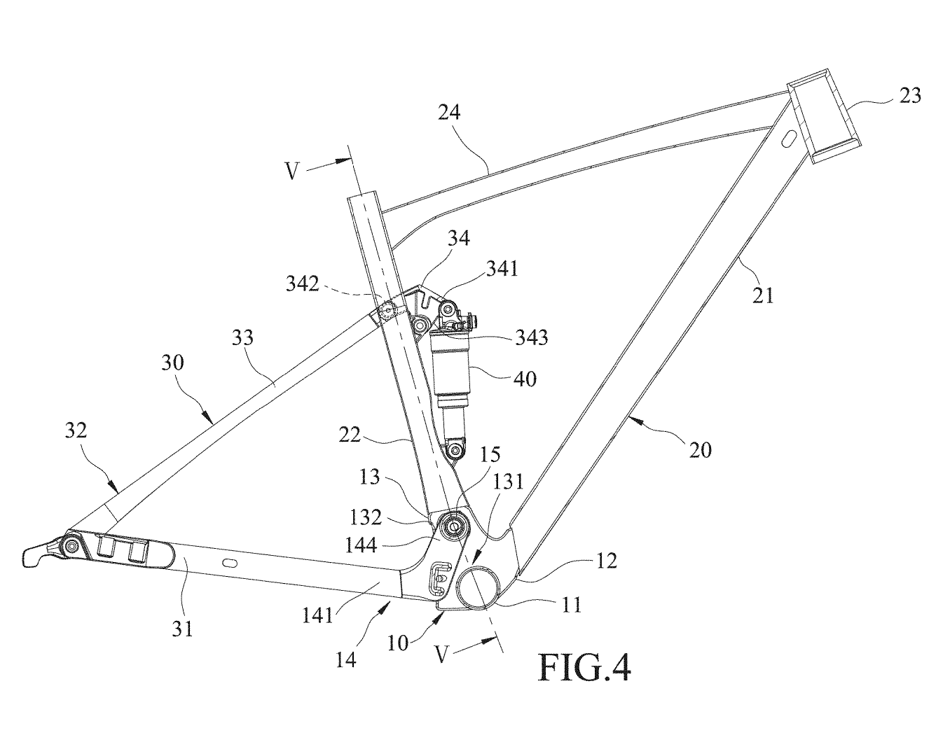

The axial hole 143 extends through the front end portions 144 and the crosspiece 142 along the pivot axis (L). In this embodiment, with reference to FIGS. 4 and 5, the pivot shaft 15 is disposed in the axial hole 143 and extends along the pivot axis (L) to be mounted on the side walls 133 of the first seat tube 13. Each of the anti-friction bearings 16 is disposed between the pivot shaft 15 and the respective one of the front end portions 144. The anti-friction bearings 16 are spaced apart from each other in the left-and-right direction. Hence, the front end portions 144 are pivotably mounted on the first seat tube 13 by virtue of the pivot shaft 15 and the anti-friction bearings 16.

Referring back to FIGS. 2 to 4, the front frame body 20 includes a second down tube 21 which is connected to and extends forwardly and upwardly from the first down tube 12, a second seat tube 22 which is connected to and extends upwardly from the first seat tube 13, a head tube 23 which is connected to and extends upwardly from the second down tube 21, and a top tube 24 which is connected between the second seat tube 22 and the head tube 23. In this embodiment, the second down tube 21 is integrally connected with the first down tube 12, and the second seat tube 22 is integrally connected with the first seat tube 13.

The rear frame body 30 includes two chain stay forks 31 each of which is connected to and extends rearwardly from the respective rear fork rod 141, and a rear stay 32 which is connected to and extends forwardly and upwardly from the chain stay forks 31. In this embodiment, the chain stay forks 31 are integrally connected with the rear fork rods 141.

The rear stay 32 has two rear stay forks 33 which are respectively connected to the chain stay forks 31 and which are spaced apart from each other in the left-and-right direction, and a cross lever 34 which extends in the left-and-right direction to interconnect the rear stay forks 33. The cross lever 34 is pivotably connected to the second seat tube 22. In this embodiment, the cross lever 34 has a front lever end 341 which is pivotably connected to the shock absorber 40, a rear lever end 342 which is connected to the rear stay forks 33, and a fulcrum portion 343 which is interposed between the front and rear lever ends 341, 342 and which is pivotably connected to the second seat tube 22.

The shock absorber 40 is disposed between the front frame body 20 and the rear stay 32. In this embodiment, the shock absorber 40 is disposed between the second seat tube 22 and the cross lever 34. Specifically, the shock absorber 40 has upper and lower ends which are pivotably connected to the front lever end 341 of the cross lever 34 and the second seat tube 22, respectively. Since the structure of the shock absorber 40 is of a known type, a description thereof is dispensed with herein. The shock absorber 40 may be a hydraulic or pneumatic type, a mechanical type such as a biasing spring, etc.

With the front end portions 144 of the rear fork rods 141 which are concealed in the receiving space 131 in the first seat tube 13, the rear fork rods 141 are prevented from generating undesired wind resistance, and the aesthetic appeal of the bicycle frame 1 is satisfactory.

Alternatively, the rear fork assembly 14 may have the front end portions 144 of the rear fork rods 141 separated from each other without providing the tubular crosspiece 142. Still alternatively, without the tubular crosspiece 142, the front end portions 144 of the rear fork rods 141 may be combined to be a single front end portion that is pivotably connected to the first seat tube 13.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A bottom bracket device comprising:
a bottom bracket shell surrounding a spindle axis in a left-and-right direction to have left and right opened ends;
a first down tube connected to and extending forwardly from said bottom bracket shell;
a first seat tube connected to and extending upwardly from said bottom bracket shell, and having two side walls which are disposed between said left and right opened ends in the left-and-right direction, said side walls defining therebetween a receiving space which has a rear access opening that is opposite to said first down tube in a front-and-rear direction; and
a rear fork assembly having at least one front end portion which is inserted into said receiving space from said rear access opening and which is pivotably connected to said side walls of said first seat tube about a pivot axis in the left-and-right direction.

2. The bottom bracket device as claimed in claim 1, wherein said rear fork assembly has two of said front end portions, said rear fork assembly including two rear fork rods each of which has at a front end thereof a respective one of said front end portions, said front end portions of said rear fork rods being inserted into said receiving space and being spaced apart from each other in the left-and-right direction.

3. The bottom bracket device as claimed in claim 2, wherein said first seat tube is connected to said first down tube at said bottom bracket shell.

4. The bottom bracket device as claimed in claim 2, wherein said front end portion of each of said rear fork rods is disposed upwardly of said bottom bracket shell.

5. The bottom bracket device as claimed in claim 2, wherein said rear fork assembly includes a tubular crosspiece which extends in the left-and-right direction to interconnect said front end portions, and an axial hole which extends through said front end portions and said crosspiece, said bottom bracket device further comprising a pivot shaft which is disposed in said axial hole and which extends along the pivot axis to be mounted on said side walls of said first seat tube.

6. The bottom bracket device as claimed in claim 5, further comprising two anti-friction bearings, each disposed between said pivot shaft and the respective one of said front end portions.

7. A bicycle frame comprising:
a bottom bracket device as claimed in claim 1;
a front frame body including a second down tube which is connected to and extends forwardly and upwardly from said first down tube, and a second seat tube which is connected to and extends upwardly from said first seat tube;
a rear frame body including two chain stay forks each of which is connected to and extends rearwardly from said rear fork assembly, and a rear stay which is connected to and extends forwardly and upwardly from said chain stay forks; and
a shock absorber disposed between said front frame body and said rear stay.

8. The bicycle frame as claimed in claim 7, wherein said rear fork assembly has two of said front end portions, said rear fork assembly including two rear fork rods each having at a front end thereof a respective one of said front end portions, said front end portions of said rear fork rods being inserted into said receiving space and being spaced apart from each other in the left-and-right direction, said chain stay forks being connected to said rear fork rods, respectively, said front frame body further including a head tube which is connected to and extends upwardly from said second down tube, and a top tube which is connected between said second seat tube and said head tube.

9. The bicycle frame as claimed in claim 7, wherein said rear stay has two rear stay forks which are respectively connected to said chain stay forks and which are spaced apart from each other in the left-and-right direction, and a cross lever which extends in the left-and-right direction to interconnect said rear stay forks, said cross lever being pivotably connected to said second seat tube, said shock absorber having upper and lower ends which are connected to said cross lever and said second seat tube, respectively.

10. The bicycle frame as claimed in claim 9, wherein said cross lever has a front lever end which is pivotably connected to said upper end of said shock absorber, a rear lever end which is connected to said rear stay forks, and a fulcrum portion which is interposed between said front and rear lever ends and which is pivotably connected to said second seat tube.
